(19) United States
(12) Patent Application Publication
(10) Pub. No.: US 2004/0049331 A1
(43) Pub. Date: Mar. 11, 2004

(54) Vehicle safety system incorporating inner and outer deployable air bags for providing energy absorption and redirection in response to a collision

(76) Inventor: Phillip Schneider, Davison, MI (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/237,575

(22) Filed: Sep. 9, 2002

(51) Int. Cl. B60R 21/00

(52) U.S. Cl. 701/45; 180/271; 280/735

(57) ABSTRACT

An absorption and redirection system for use with a vehicle including a first plurality of exterior air bag actuating units mounted at specified locations along at least one of front, sides and rear of the vehicle. A second plurality of interior air bag actuating units are mounted at specified locations along at least a front, sides and rear of a vehicle interior. An emitter/receptor is associated with each of the first plurality of exterior air bag actuating units and for identifying an approaching object. A processor is in operative communication with each of the first and second pluralities of air bag actuating units and, upon receipt of an input signal associated with at least one of the emitter/receptors, instructs the inflation of a given sub-plurality of air bags associated with each of the first and second bag pluralities of actuating units.

### BACKGROUND OF THE INVENTION

1. Field of the Invention

The present invention relates generally to vehicle restraint and impact/collision assemblies for protecting the vehicle operator, occupants and others. More particularly, the present invention discloses an energy absorption and redirection system which functions to deploy a given number of inner and outer positioned air bag assemblies, and prior to contact with a moving or non-moving object or obstruction. The vehicle safety system subsequently absorbs a specified degree of impact force resulting from the contact or collision, with the exteriorly actuated air bags additionally providing energy redirection of the remaining force so as to keep the vehicle moving in its generally previous direction.

2. Description of the Prior Art

Various systems and assemblies are known in the art for sensing and, to some extent, responding to vehicle impacts or collisions. The purpose, in every such instance, is to attempt to avoid or minimize injury to the vehicle occupants as well as to the vehicle itself.

U.S. Pat. No. 6,416,093, issued to Schneider, discloses an energy absorption, rotation and redirection system for use with a vehicle traveling astride a barrier, the vehicle including a front end with a bumper and first and second sides. The system includes a plurality of air bag actuating units mounted at specified locations along the front end and first and second sides of the vehicle. Preferably three air bag units are located at spaced intervals along the front bumper of the vehicle, with individual and additional air bags being located on the sides of the vehicle.

Schneider '093 also teaches an activator mechanism associated with one or more of the actuating units for selectively instructing the inflation of an exterior air bag associated with the given bag actuating unit. The activator mechanism includes a reflective target strip applied along the barrier, as well as laser emitter/receptor units associated with each of the air bag actuating units. A computerized processor and memory chip is located in the vehicle and instructs the issuance of a lasing pattern from each of the emitter/receptor units. Upon at least one of the emitter/receptor units receiving a reflection from the target strip, indicative of a given orientation of the vehicle relative to the concrete wall barrier, the activator mechanism directs deployment of the external air bags and prior to the vehicle striking the barrier. The vehicle subsequently rotates and redirects about the barrier concurrent with the barrier absorbing a determined percentage of force associated with the contact.

U.S. Pat. No. 6,085,151, issued to Farmer et al., teaches a predictive collision sensing system in which a relatively narrow beam of either a radio frequency (RF) or optical electromagnetic radiation is scanned over a relatively wide azimuthal range. A return signal is processed to detect a range and velocity of each point of reflection. Individual targets are then identified by clustering analysis and are tracked in a Cartesian coordinate system. The threat posed to the vehicle for a given target is assessed from estimates of its relative distance, velocity, and size. In response, one or more vehicular devices (air bags, seat belt pretensioners and deployable knee bolsters) are controlled in response to the assessment of threat so as to enhance the safety of the vehicle occupant.

U.S. Pat. No. 5,957,616, issued to Fitch, discloses a sacrificial (frangible) and inertial impact attenuating barrier which includes a thin walled plastic tub containing an energy absorbing and dispersible mass, such as water or sand. The tub is supported on a thin-walled plastic ring which elevates the dispersible mass to a height at which its center of gravity is the same as that of a particular racing vehicle, such as a Formula I car or the like.

U.S. Pat. No. 5,192,838, issued to Breed et al., discloses frontal impact crush zone crash sensors for determining sufficient impact force to trigger an air bag passenger restraint system. The sensors are intertially damped, with a dampening force calculated to be proportional to the square to velocity. The sensors are constructed of plastic and in the shape of short round or rectangular cylinders. The particular shape of the sensors minimizes the chance that they will be rotated during a crash and the sensors are further disclosed as installed on the frontal radiator structure or at such similar locations near the front of the vehicle. A typical crash sensor further includes a hinged plastic mass attached to the housing, the mass activating a contact assembly after a predetermined movement of the mass, and with a gap existing between the movable mass and interior wall of the housing to enhance damping of the crash sensor.

U.S. Pat. No. 5,489,117, issued to Huber, teaches an occupant restraint system incorporating a cushioning structure or air bag having, an impermeable external wall and a permeable internal wall with gas passageways therebetween. The air bag is mounted on a pair of gas manifolds having manifold gas ports communicating with the gas passageways in the air bag. Gas generator units are secured to the manifolds and are actuable through impact signals to create high pressure gas directed through generator nozzles into the manifolds and subsequently into gas passageways of the air bag. A valve plate supports a plurality of inlet reed valves operating in conjunction with a corresponding plurality of inlet ports to admit ambient air from within the vehicle into the expanding air bag. A pair of bi-level exhaust valves permit the escape of high pressure gas and air from within the air bag into the vehicle interior upon completion of the deployment of the air bag. The exhaust valves restrict the rate of exit of the gas and air from within the air bag when an increase in the internal air bag pressure occurs such as caused by occupant impact.

Finally, U.S. Pat. No. 5,338,061, issued to Nelson et al., teaches another variation of air bag having double walled construction. The air bag is fitted to the housing of a gas generator and a gas jet opening allows the air bag to communicate with the housing. A gas generated by the gas generator, due to an impact, is charged into the air bag. The double wall construction of the air bag is such that a secondary outer bag has a greater volume or holding capacity than an initial and interiorly housed bag. The first air bag constitutes an air storage chamber which receives air from the atmosphere through an air intake path and stores the air. A gas storage chamber is formed between the first and second air bags and receives a combustion gas from the gas jet opening and temporarily stores the combustion gas. The air intake path is further typically a hollow path between the atmosphere and the air storage chamber and the first air bag has an opening therein which establishes communication between the gas storage chamber and the air storage chamber.

### SUMMARY OF THE PRESENT INVENTION

The present invention is an energy absorption and redirection system which functions to deploy a given number of inner and outer positioned air bag assemblies, and prior to contact with a moving or non-moving object or obstruction. As previously explained, the vehicle safety system subsequently absorbs a specified degree of impact force, resulting from the contact or collision, with the exteriorly actuated air bags additionally providing energy redirection of the remaining force so as to keep the vehicle moving in its generally previous direction.

The present invention operates under the theory that, it being impractical to attempt to substantially absorb forces resulting from impact collisions with a surrounding barrier, it is preferable to attempt to absorb a percentage of the impact forces, concurrent with converting a remainder of the impact forces in a redirecting manner about the movable object or fixed obstruction. It is further a principle of physics that circular/redirecting motion, unless reinforced, naturally dissipates energy and it is therefore desirous to employ this concept to assist in preventing injury and death to the vehicle occupants and which would otherwise tend to occur in instances where massive impact forces are redirected to the vehicle, and subsequently to the individual(s) within the vehicle.

Accordingly, the present invention includes the provision of a plurality of exterior air bag actuating units located along the front, sides and rear of the vehicle within which the system is installed. In a desired embodiment, a plurality of three exterior bag actuating units are installed within the area of the front bumper of the vehicle, with an additional pair exterior actuating units located along each side of the vehicle and at least one additional actuating unit located along the rear bumper of the vehicle. The actuating units are preferably in the form of insertable and replaceable cartridges which recess within the vehicle body and which, in certain instances, may be quickly replaced. Additional air bag actuating units are secured at various locations along the vehicle interior, and such as typically along the front and sides of the passenger compartment interior, as well as potentially the rear interior of the passenger compartment.

An activator mechanism is provided for actuation/deployment of both the externally and internally located air bags and includes an on-board processor and memory chip arrangement which communicates with each of the individual air bag actuating units. Each of the exteriorly positioned air bag units further includes a laser emitter/receptor which is instructed by the processor to issue a lasing pattern having a specified width and direction.

Upon the on-board processor being notified of and evaluating the trajectory of an incoming obstruction or object, the processor proceeds to calculate a closing speed and distance of the object/obstruction relative to the vehicle. In the event that the processor determines, upon communicating with the memory chip, that an impact is imminent, the system acts to deploy some or all of the exterior/interior air bag actuating units in a given quadrant, location, or combination of locations of the vehicle and at a predetermined point in time preceding the moment of impact or collision.

The configuration and arrangement of the exterior deployable air bags is further such that, upon such contact or collision occurring at angles excepting a substantially perpendicular impact, a substantial force of the vehicle is redirected in a rotating fashion, concurrent with a remaining component of the force being absorbed between the internal/external bags. In the rare instance in which the vehicle impacts an object or obstruction (such as a wall or head-on collision with another vehicle) and in substantially direct (non-angular) fashion in which the system is unable to rotate, the result is a cushioning of the impact force resulting from the successive impact and collapse of the forwardly mounted external air bags and the subsequent deployment of the interiorly mounted air bags.

Yet additional advantages provided by the system of the present invention is the configuration of the external air bags with a suitable three dimensional shape and size (typically spheroid related) which will not substantially impair the vehicle operator's field of vision. To further enhance the durability and effectiveness of the bags, they are typically constructed of a heavy duty nylon type of material and, in certain applications, may further be provided with concentric inner and outer layers which take into account the potential of the outer layer being punctured by sharp metal edges or the like and prior to the exterior deployed bags substantially fulfilling their function.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a top plan view of a vehicle in phantom and illustrating the preferred arrangement of the insertable and recessed cartridges, defining the exterior air bag actuating units, as well as those associated with the interior air bag actuating units, and further illustrating the manner in which the individual exterior units communicate with the on-board controller to accomplish the sensing, evaluation and deployment of the exterior and interior bags according to the present invention;

FIG. 2 is a top plan view illustrating a first vehicle outfitted with the safety system according to the present invention, arranged in a collision course with a second vehicle, and in which the emitter/receptor units associated with the exterior bags sense and communicate the approach of the second vehicle at a first determined distance D1;

FIG. 3 is a view similar to that shown in FIG. 2 and in which, responsive to a determined closing distance D2, the on-board processor within the first vehicle deploys a selected plurality of interior/exterior air bag actuating units according to the present invention;

FIG. 4 is a top plan view of an alternate collision course established between a first vehicle outfitted with the safety system and a second vehicle and in which, again at a determined closing distance D2, the on-board processor deploys a further selected plurality of interior/exterior air bag actuating units according to the present invention;

FIG. 5 is a top plan view of yet a further and impending rear collision condition between a first vehicle outfitted with the safety system and a second vehicle and illustrating, again at a determined closing distance D2, a rear actuating exterior air bag unit according to the present invention;

FIG. 6 is a sectional view, in perspective, of a selected and exterior air bag actuating unit according to the present invention; and

FIG. 7 is a sectional view of an individual (and typically exterior) air bag actuating unit, and illustrating in cutaway nature the dual stage nature of the actuated bag with inner and outer layers.

### DETAILED DESCRIPTION OF THE PREFERRED EMBODIMENTS

Referring now to FIG. 1, a plan view is illustrated at 10 of a vehicle safety system incorporating inner and outer air bag actuating units according to the present invention. As previously indicated, the system 10 functions to deploy a given number of inner and outer positioned air bag assemblies, and prior to the occurrence of a collision condition with a moving object or non-moving obstruction. The vehicle safety system subsequently absorbs a specified degree of impact force resulting from the contact or collision, with the exteriorly actuated air bags additionally providing energy redirection of the remaining force so as to keep the vehicle moving in its generally previous direction.

Referring again to FIG. 1, a first selected vehicle is indicated at 12, illustrated in phantom, and incorporating the various components and subassemblies making up the safety system of the present invention. In particular, a first plurality of exterior air bag actuating units are provided along the front, sides and rear of the vehicle 12. According to one desired embodiment, this includes a plurality of first 14, second 16 and third 18 such actuating units located at spaced intervals along a front end 20 of the vehicle 12 and in recessed fashion within a vehicle bumper 22 associated with the front end 20. Additional air bag actuating units 24 & 26 and 28 & 30 are located in associating manner with driver and passenger sides 32 and 34, respectively, of the vehicle and, in particular, are recess mounted within the driver 32 and passenger 34 side front and rear doors. Finally a yet additional air bag actuating unit 36 is located in likewise recessed fashion along a rear bumper 38 of the vehicle.

An additional interior plurality of air bag actuating units are indicated and which are secured at various locations along the vehicle interior. These further typically include interior units 40 and 42, secured along a frontward extending location of the vehicle interior such as corresponding to the vehicle instrument panel, and additional interior units 44 & 46 and 48 & 50, and located along the front and sides of the passenger compartment interior. A rear interior unit 49 can also be provided along the rear of the passenger compartment interior.

As will be subsequently described in reference to the varying deployed conditions of FIGS. 3, 4, and 5, the actuating units, when triggered as will be subsequently described, each deploy selected plurality or sub-plurality of interior and exterior air bag units. As is also known in the art, the bags are each constructed with a specified spheroidal or other suitable three dimensional shape and size to provide maximum protection, energy absorption and, in particular reference to the exterior mounted bags, energy redirection of the vehicle 12.

Referring to FIG. 6, a sectional representation is shown of a selected air bag actuation unit, this being an exterior actuated air bag unit and which is designated as first and forward actuating unit 14, it being understood that the identical description applies to each other front 16 and 18, side 24, 26, 28 and 30 and rear 36 exterior mounted units. The actuation units are each further constructed, in one embodiment, of an insertable and replaceable cartridge unit and which may be capable of being inserted and removed from the varying locations of the vehicle 12, although it is contemplated that the units may otherwise be fixed to the vehicle.

As is further illustrated in FIG. 4, each individual and exterior actuating unit (see again unit 14) is further constructed of a specified three dimensional shape and size, such as rectangular although not limited to any specific shape and/or size. The exterior actuating unit further includes a scored, slitted or perforated configuration 52 defined within a specified facing surface 54 of the selected unit 14.

In order to deploy any selected plurality, or sub-plurality of the external air bags 14, 16, 18, 24, 26, 28, 30 and 36, as well as any selected plurality or sub-plurality of the interior air bags 44, 46, 48, 49 and 50, an activator mechanism is incorporated into the system 10 and includes an on-board mounted computer processor/controller 56 (CPU), see again both FIGS. 1 and 6. The CPU/controller 56 includes a built-in memory chip (such as further commonly known as a look-up table).

Referring again to FIG. 1, and as will be subsequently described in more detail, the CPU 56 is communicable to each and every of the exterior and interior air bag units. This is accomplished in the illustration of FIG. 1 through the provision of various communicating lines (or wires) extending individually from the CPU 56 to each of the individual exterior and interior bag units. It is further contemplated that, in given applications, wireless transmission and reception of signals to and from the CPU 56 to the various air bag actuation units can substitute a hard wired application of this technology.

In a first sensing and evaluating condition, see again FIG. 2, the CPU 56 is communicated by the various exterior bag actuating units, again represented in FIG. 4 by first unit 14 and in particular with a laser emitter/receptor 58 arranged at a selected location along the unit 14 (such as again within the facing surface 54). It is also understood that the technology surrounding the emitting and reception of laser generated signals is known within the technical art and also that the appropriate emitter and receptor units can be combined, separated and/or located either as a part of the associated actuating units or separated from the units and located at alternate positions in and around the vehicle within the scope of the present invention.

In embodiment illustrated, the emitter/receptor (again at 58 for first unit 14) is instructed by the CPU/processor 50 to issue a lasing pattern of specified range (and illustrated by directional arrows 60, 62 and 64 in FIG. 4). Referring again to the illustration of FIG. 1, as well as to the various and alternating applications of FIGS. 2-5, individual laser patterns are illustrated for each of the exterior actuating units and which correspond to those illustrated for example at 60, 62 and 64 in FIG. 4. Accordingly, a repetitive description of each seat of lasing patterns associated with each of the exteriorly mounted bag units is unnecessary. In any desired embodiment, the exteriorly directed lasing patterns (see again at 60, 62 and 64) may exhibit either a limited two dimensional or a varying three dimensional range (both linearly and/or vertically) as determined along its longitudinal traveling distance.

Referring to FIG. 2, a first vehicle (again vehicle 12 in FIG. 1) is outfitted with the safety system according to the present invention, and is illustrated arranged in a collision course with a second vehicle 66. Given the orientation of the vehicles 12 and 66, and upon the emitter/receptor units, associated with the front positioned and exterior bag units 14, 16 and 18 of the first vehicle 12, issuing lasing patterns which detect the approach of the second vehicle 66 to a determined distance D1 68, this information is communicated to the CPU 56.

Referring further to FIG. 3, and in response to a determined closing distance D2 70, the on-board processor (again CPU 56) within the first vehicle deploys a selected plurality (or sub-plurality) of both the interior and exterior air bag actuating units, this occurring further upon the processor analyzing the speed, distance and orientation of the vehicle 12 relative to the barrier 16 and to determine if a wall impact is inevitable and if so, when it is desirable to deploy the exterior bags. In particular, exterior air bags 72, 74 and 76, associated with the exterior actuating units 14, 16, and 18, respectively, as well as interior air bags 78 and 80, associated with interior actuating units 40 and 42, respectively, are deployed by an appropriate signal issued from the CPU 56. Referring back to FIG. 6, the deployment of each air bag (either inner or outer) is assisted through the release of a carbon dioxide (CO₂) or other suitable charge 82 which quickly and effectively inflates the bag.

In this manner, the forces which would otherwise result from impact or collision are to a significant degree reduced or ameliorated by virtue of the CPU 56 timely instructing the desired plurality of sub-plurality of exterior and interior air bag units to deploy and prior to the actual collision occurring. Accordingly, a first component of the collision force is absorbed by the inner and outer situated air bags, and an additional component is redirected by virtue of the forces applied along the exteriorly mounted bags of the vehicle 12.

Referring now to FIG. 4, a top plan view is illustrated of an alternate and impending collision condition established between the first vehicle 12 outfitted with the safety system and a second vehicle (again referenced at 66). In the embodiment of FIG. 4, the impending collision occurs along the driver side 32 of the first vehicle 12, and as opposed to head-on in FIGS. 2 and 3.

The CPU 56 again is notified (see at 83) upon lasing patterns emitted by the exterior side actuating units 24 and 26 detecting the existence and approach of the second vehicle 66. Upon a determined closing distance D1 84, the on-board processor instructs the deployment of a further selected plurality of interior/exterior air bag actuating units and prior to a closing distance D2 86 being achieved. In particular, exterior side air bags 88 and 90 are actuated in this application, corresponding to exterior side units 24 and 26. Interior side air bags 92 and 94 are likewise deployed and correspond to side units 44 and 46.

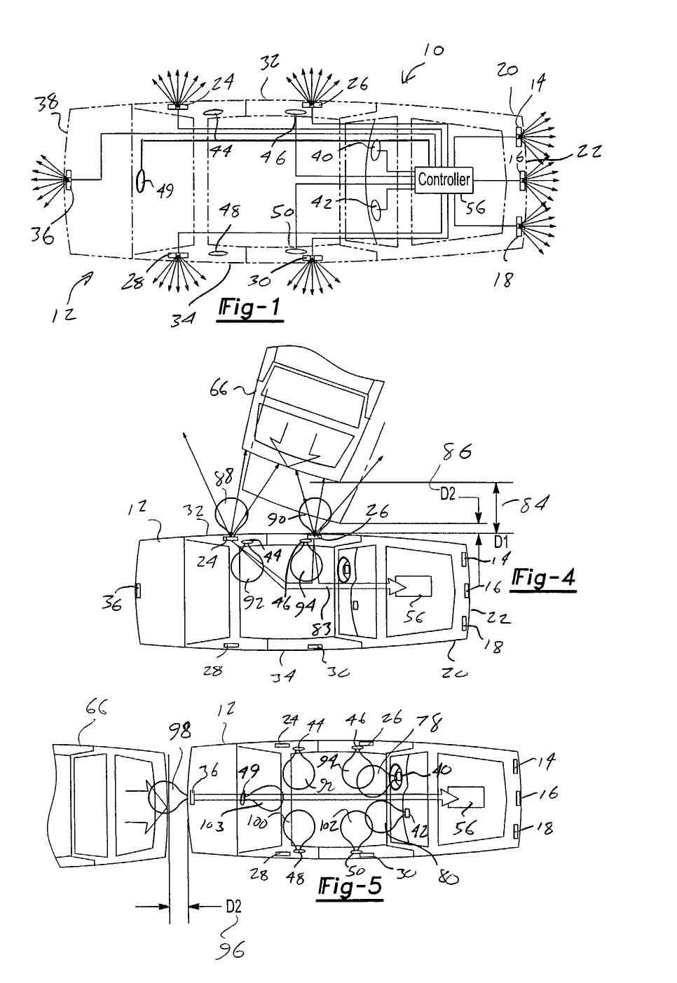

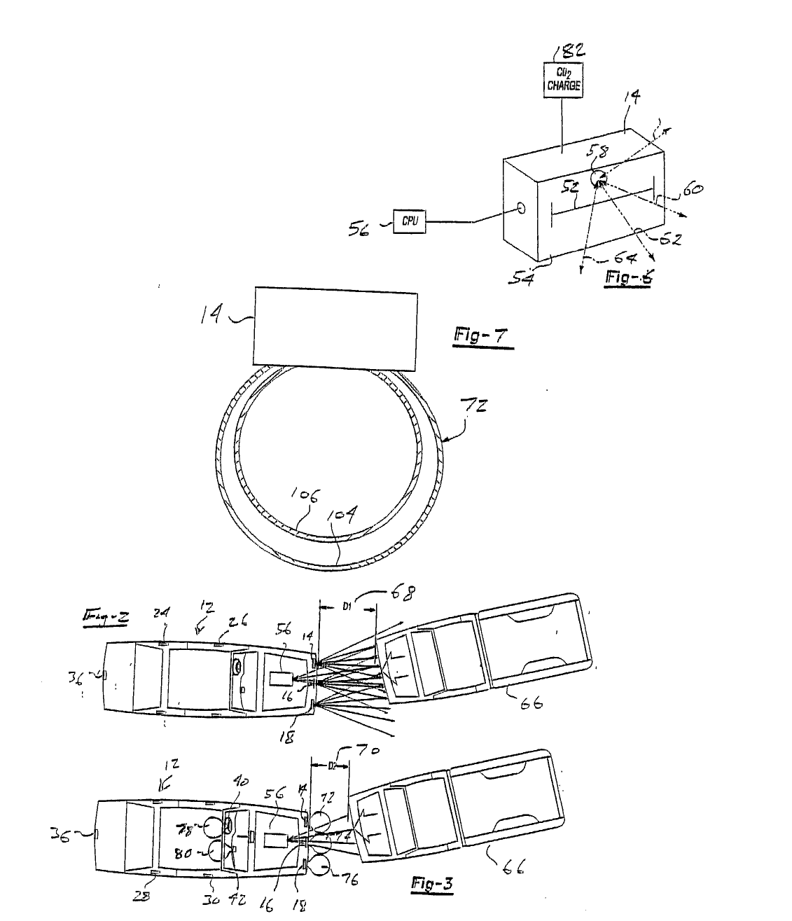

FIG. 5 illustrates yet a further and impending rear collision condition between a first vehicle 12, again outfitted with the safety system, and a second vehicle 66 and illustrating, again at a determined closing distance D2 96, deployment of a rear exterior air bag 98 corresponding to rear actuating exterior air bag unit 36. In corresponding fashion, the CPU 56 instructs all of the interior air bags to activate and as illustrated by front interior bags 78 and 80, driver's side interior bags 92 and 94, passenger side interior bags 100 and 102, and passenger rear interior bag 103.

Referring finally to FIG. 7, a selected and externally actuated bag (see air bag 72 for first actuating unit 14) is illustrated in cutaway fashion and which, in a further preferred variant, shows a dual layer construction with a first external layer 104 and a second inner and concentric layer 106. The construction of the bag assembly and the manner in which the dual layers are deployed provides an increased degree of resiliency to the assembly. Specifically, sharp metal edges and the like often exist in a given collision environment and the ability to provide a dual layer bag increases its effectiveness in the event that the outer layer becomes pierced.

Additionally, the severity of the vehicle impact may also affect the integrity of a single walled air bag construction and the provision of the inner and outer layers provide a further measure of resiliency. As previously described, the air bags (both inner as well as outer) can each be constructed of a heavy duty nylon or like material and it is further contemplated that additional and suitable materials, such as steel mesh screening mixed with other suitable flexible and substantially air tight composites may be employed to provide the requisite degree of strength and impact-resistance.

Having described my invention, additional preferred embodiments will become apparent to those skilled in the art to which it pertains, and without deviating from the scope of the appended claims.

I claim:

1. An absorption and redirection system for use with a vehicle, comprising:
a first plurality of exterior air bag actuating units mounted at specified locations along at least one of front, sides and rear of the vehicle;
a second plurality of interior air bag actuating units mounted at specified locations along at least a front, sides and rear of a vehicle interior;
an emitter/receptor associated with each of said first plurality of exterior air bag actuating units and for identifying an approaching object; and
a processor in operative communication with each of said first and second pluralities of air bag actuating units and, upon receipt of an input signal associated with at least one of said emitter/receptors, instructing the inflation of an air bag associated with at least one each of said first and second pluralities of bag actuating units.

2. The system as described in claim 1, further comprising each of said emitter/receptors issuing a lasing pattern which, upon the vehicle achieving a specified orientation relative to the approaching object, instructs said processor as to a closing distance, angle and/or speed of the vehicle relative to the object.

3. The system as described in claim 1, said first plurality of air bag actuating units further comprising a sub-plurality of first, second and third air bag actuating units positioned at spaced intervals along the bumper, a sub-plurality of first and second air bag actuating unit being located within side doors associated with first and second sides of the vehicle, and a rear air bag actuating unit being located within a bumper of the vehicle.

4. The system as described in claim 3, each of said exterior air bag actuating units being recessed a given distance within at least one of front, sides and rear of the vehicle.

5. The system as described in claim 4, each of said exterior air bag actuating units further comprising a removable/replaceable cartridge which is installed within an associated pocket defined within the front, sides and rear of the vehicle.

6. The system as described in claim 3, an exteriorly inflatable air bag associated with each of said air bag actuating units further comprising a substantially three dimensional and spherical shape.

7. The system as described in claim 1, said second plurality of air bag actuating units further comprising a sub-plurality of first and second air bag actuating units positioned at spaced intervals along the forward interior of the passenger compartment, a sub-plurality of first and second air bag actuating unit being located along first and second extending side interiors of the vehicle.

8. The system as described in claim 1, each of said air bags further comprising a reinforced nylon type material.

9. The system as described in claim 1, each of said air bags associated with said first plurality of air bag actuating units further comprising a dual layer construction with an exterior layer and an interior and substantially concentric inner layer.
